(19) United States
(12) Patent Application Publication
(10) Pub. No.: US 2020/0310419 A1
(43) Pub. Date: Oct. 1, 2020

(54) VEHICLE CONTROL DEVICE, VEHICLE CONTROL METHOD, AND COMPUTER-READABLE RECORDING MEDIUM

(71) Applicant: SUBARU CORPORATION, Tokyo (JP)

(72) Inventors: Fumiya SATO, Tokyo (JP); Hideyuki TAKAO, Tokyo (JP); Tsuyoshi YAMASAKI, Tokyo (JP)

(73) Assignee: SUBARU CORPORATION, Tokyo (JP)

(21) Appl. No.: 16/794,463

(22) Filed: Feb. 19, 2020

(30) Foreign Application Priority Data
Mar. 25, 2019 (JP) 2019-057064
Mar. 25, 2019 (JP) 2019-057065

(51) Int. Cl. G05D 1/00; B60W 40/068; B60W 50/12; B60W 40/107

(52) U.S. Cl. CPC G05D 1/0066; B60W 40/068; B60W 40/107; G05D 1/0061; B60W 50/12

(57) ABSTRACT

A vehicle control device includes a processor. The processor estimates a coefficient of friction on a road surface to be traveled by a vehicle. The processor determines whether to continue automated driving on the condition that the vehicle is performing the automated driving. On the condition that a determination is made that the automated driving is noncontinuable, the processor imposes a restriction on driving force of the vehicle in manual driving on the basis of a restrictive value derived from the coefficient of friction estimated.

### CROSS-REFERENCE TO RELATED APPLICATIONS

This application claims priority from Japanese Patent Application Nos. 2019-057064 and 2019-057065, both filed on Mar. 25, 2019, the entire contents of which are hereby incorporated by reference.

### BACKGROUND

The technology relates to a vehicle control device, a vehicle control method, and a computer-readable recording medium.

For example, as described in Japanese Unexamined Patent Application Publication (JP-A) No. 2016-115356, in a case with a determination that automated driving is difficult to continue, a driver's awakeness is checked. In a case where the driver is able to perform manual driving, a transition is made from the automated driving to the manual driving. In a case where the driver is unable to perform the manual driving, an emergency retreat is made.

### SUMMARY

An aspect of the technology provides a vehicle control device including a processor. The processor is configured to estimate a coefficient of friction on a road surface to be traveled by a vehicle. The processor is configured to determine whether to continue automated driving on the condition that the vehicle is performing the automated driving. The processor is configured to impose a restriction on driving force of the vehicle in manual driving on the basis of a restrictive value derived from the coefficient of friction estimated, on the condition that a determination is made that the automated driving is noncontinuable.

An aspect of the technology provides a vehicle control method including: estimating a coefficient of friction on a road surface to be traveled by a vehicle on the basis of data detected by a sensor; determining whether to continue automated driving on the condition that the vehicle is performing the automated driving; and imposing a restriction on driving force of the vehicle in manual driving on the basis of a restrictive value derived from the coefficient of friction estimated, on the condition that a determination is made that the automated driving is noncontinuable.

An aspect of the technology provides a computer-readable recording medium containing a program. The program causes, when executed by a computer, the computer to implement a method, the method including: estimating a coefficient of friction on a road surface to be traveled by a vehicle on the basis of data detected by a sensor; determining whether to continue automated driving on the condition that the vehicle is performing the automated driving; and imposing a restriction on driving force of the vehicle in manual driving on the basis of a restrictive value derived from the coefficient of friction estimated, on the condition that a determination is made that the automated driving is noncontinuable.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 schematically illustrates a configuration of a vehicle system according to an embodiment of the technology.

FIG. 2A is a schematic diagram illustrating a map to be used by a road surface friction coefficient calculator in determining a road surface state.

FIG. 2B is a schematic diagram illustrating a coordinate system of the three-dimensional map in FIG. 2A.

FIG. 2C is a schematic diagram illustrating a two-dimensional map into which the three-dimensional map in FIG. 2A is decomposed.

FIG. 2D is a schematic diagram illustrating a two-dimensional map into which the three-dimensional map in FIG. 2A is decomposed.

FIG. 2E is a schematic diagram illustrating a two-dimensional map into which the three-dimensional map in FIG. 2A is decomposed.

FIG. 3 schematically illustrates an example of a database that defines, in advance, relation of road surface conditions and a coefficient of friction.

FIG. 4 is a flowchart illustrating processing to be performed in the vehicle system according to the embodiment of the technology.

FIGS. 5A and 5B are schematic diagrams provided for description of driving force in accordance with the road surface conditions in step S22 in FIG. 4 in Example 1.

FIG. 6 is a timing chart illustrating how the driving force is restricted in switching to manual driving in Example 1.

FIGS. 7A and 7B are schematic diagrams provided for the description of the driving force in accordance with the road surface conditions in step S22 in FIG. 4 in Example 2.

FIG. 8 schematically illustrates how a margin for front lateral force is generated by restricting front driving force in FIG. 7A in Example 2.

FIG. 9 is a timing chart illustrating how the driving force is restricted in switching to unautomated driving in Example 2.

FIG. 10 is a timing chart illustrating how the driving force is restricted in Example 2, with a restrictive value on rear driving force being set on the basis of a lower limit of a coefficient of friction on a road surface, and with a restrictive value on the front driving force being set in accordance with front and rear driving force distribution.

FIG. 11 schematically illustrates an ideal driving force diagram in Example 2.

### DETAILED DESCRIPTION

Automated driving of vehicles is performed on the basis of various kinds of sensor data. For example, in a case where a situation arises that effective sensor data is unacquirable, it is assumed that switching is made from the automated driving to manual driving. In the switching from the automated driving to the manual driving, however, a driver's abrupt operation of an accelerator, a brake, or a steering wheel would cause unstable vehicle behavior. The technique described in JP-A No. 2016-115356 barely takes into consideration such disordered vehicle behavior in the switching to the manual driving.

It is desirable to provide a vehicle control device, a vehicle control method, and a computer-readable recording medium that make it possible to stabilize vehicle behavior in switching from automated driving to manual driving.

In the following, some preferred but non-limiting embodiments of the technology are described in detail with reference to the accompanying drawings. Note that the following description is directed to illustrative examples of the disclosure and not to be construed as limiting to the technology. In each of the drawings referred to in the following description, elements have different scales in order to illustrate the respective elements with sizes recognizable in the drawings. Therefore, factors including, without limitation, the number of each of the elements, the shape of each of the elements, a size of each of the elements, a dimension of each of the elements, a material of each of the elements, a ratio between the elements, relative positional relationship between the elements, and any other specific numerical value are illustrative only and not to be construed as limiting to the technology. Further, elements in the following example embodiments which are not recited in a most-generic independent claim of the disclosure are optional and may be provided on an as-needed basis. Throughout the specification and drawings, elements having substantially the same function and configuration are denoted with the same reference characters to avoid redundant description, and elements not in direct relation to the technology may not be illustrated.

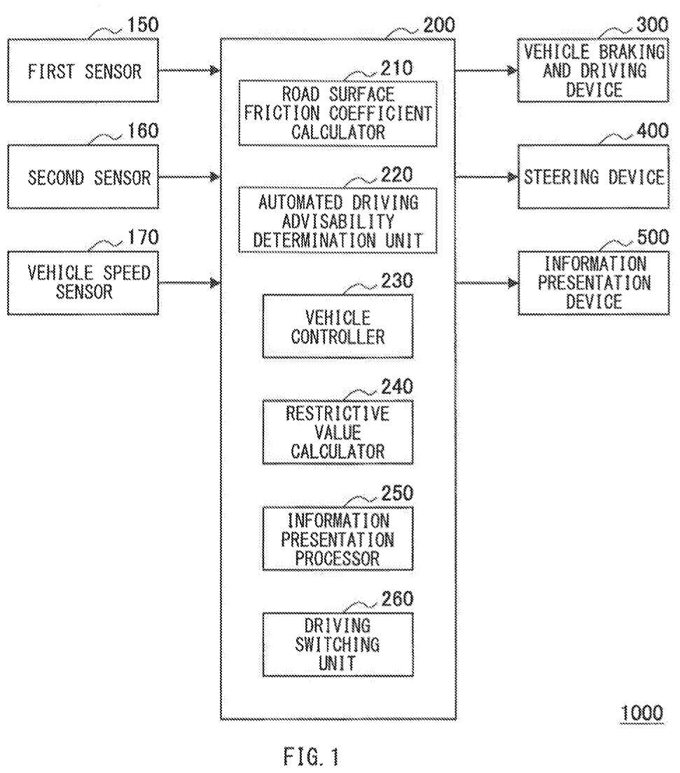

Described first, with reference to FIG. 1, is a configuration of a vehicle system 1000 according to an embodiment of the technology. The vehicle system 1000 may be mounted on a vehicle such as an automobile. In this embodiment, the vehicle on which the vehicle system 1000 is mounted may be a vehicle that is able to perform automated driving and manual driving. As illustrated in FIG. 1, the vehicle system 1000 according to this embodiment may include a first sensor 150, a second sensor 160, a vehicle speed sensor 170, a control device 200, a vehicle braking and driving device 300, a steering device 400, and an information presentation device 500.

The control device 200 may perform an overall control of the vehicle system 1000. The control device 200 may include a road surface friction coefficient calculator 210, an automated driving advisability determination unit 220, a vehicle controller 230, a restrictive value calculator 240, an information presentation processor 250, and a driving switching unit 260. The road surface friction coefficient calculator 210 may be also referred to as a road surface friction coefficient estimator. It is to be noted that in one example, the components of the control device 200 illustrated in FIG. 1 may be embodied by cooperation of, for example, a central processing unit (CPU), a random access memory (RAM), and a read only memory (ROM) installed in the control device 200.

The first sensor 150 may include a hybrid sensor including a non-contact sensor, or an environment recognition sensor, such as a camera, a temperature sensor, a near-infrared sensor, millimeter wave radar, laser radar, i.e., LiDAR, and a laser light sensor, i.e., a Time of Flight (TOF) sensor. The camera may capture an image frontward of the vehicle. Non-limiting examples of the temperature sensor may include an outside air temperature sensor and a road surface temperature sensor. The first sensor 150 may detect environmental data such as the image, a temperature, a road surface state frontward of the vehicle. It is to be noted that in determining the road surface state by the first sensor 150, employed may be a method described in, for example, JP-A No. 2006-46936.

The second sensor 160 may include a sensor to be used when the vehicle performs the automated driving. The second sensor 160 may include, for example but not limited to, a positional sensor, a camera, millimeter wave radar, and laser radar. The positional sensor may be associated with a satellite positioning system such as a Global Positioning System (GPS). The camera may capture an image frontward of the vehicle. It is to be noted that part or all of the components of the first sensor 150 and the second sensor 160 may be shared by each other.

When the first sensor 150 detects, for example, the image and the temperature frontward of the vehicle, the road surface friction coefficient calculator 210 of the control device 200 may calculate, in real time, a coefficient of friction on a road surface on the basis of, for example, the image and the temperature frontward of the vehicle detected by the first sensor 150.

In one specific but non-limiting example, the road surface friction coefficient calculator 210 may acquire, for example, a color of the road surface frontward of the vehicle and road surface roughness frontward of the vehicle from the image of the camera of the first sensor 150. The road surface friction coefficient calculator 210 may acquire an outside air temperature and a road surface temperature from a non-contact thermometer of the first sensor 150.

The road surface friction coefficient calculator 210 may also acquire an amount of moisture on the road surface from a detected value of the near-infrared sensor of the first sensor 150. When the road surface is irradiated with near-infrared rays, an amount of reflected near-infrared rays decreases when the road surface has a large amount of moisture, and the amount of reflected near-infrared rays increases when the road surface has a small amount of moisture. Thus, the road surface friction coefficient calculator 210 is able to acquire the amount of moisture on the road surface on the basis of the detected value of the near-infrared sensor.

The road surface friction coefficient calculator 210 may acquire the road surface roughness from the laser light sensor of the first sensor 150. In one more specific but non-limiting example, the road surface friction coefficient calculator 210 is able to acquire the road surface roughness, or road surface unevenness, frontward of the vehicle on the basis of time from sending out of laser light to detection of reflected light. It is to be noted that the road surface friction coefficient calculator 210 may acquire the road surface roughness in a region frontward of the vehicle, in consideration of an amount of movement of the vehicle over the road surface as the vehicle travels, on the basis of a vehicle speed.

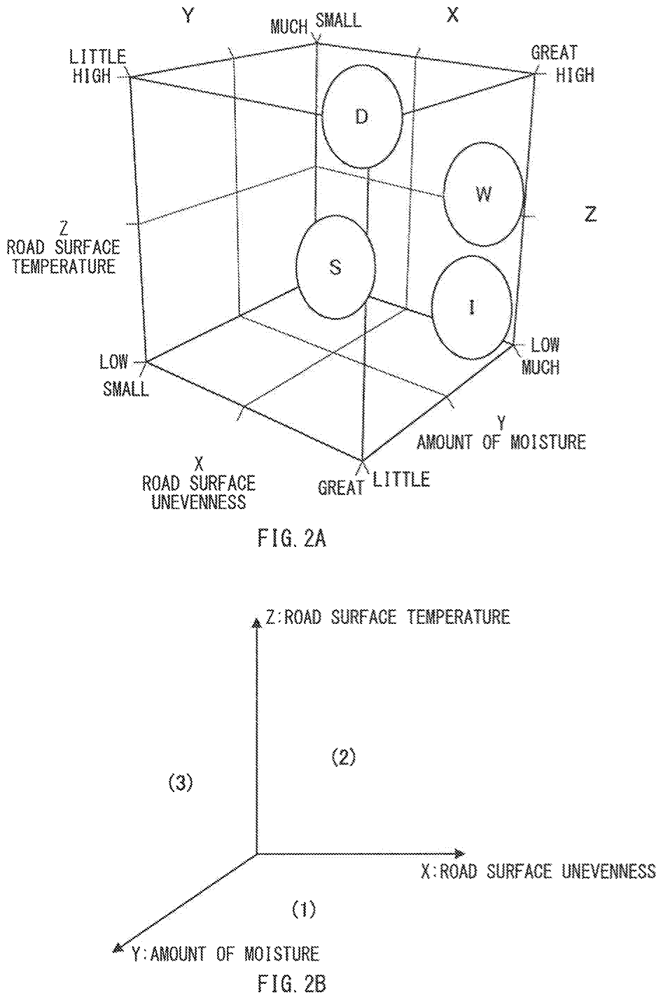

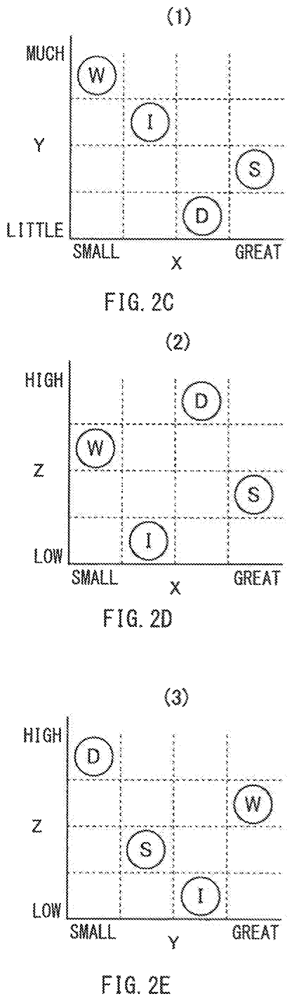

The road surface friction coefficient calculator 210 may determine, from these pieces of data acquired from the first sensor 150, which the road surface state is, dry (D), wet (W), snow (S), or ice (I). FIG. 2A is a schematic diagram illustrating a map to be used by the road surface friction coefficient calculator 210 in determining the road surface state. The map illustrated in FIG. 2A is a three-dimensional map, with normalized values of the road surface temperature, the road surface unevenness, and the amount of moisture on the road surface serving as parameters. FIG. 2B to FIG. 2E are schematic diagrams illustrating the three-dimensional map in FIG. 2A decomposed into two-dimensional maps. FIG. 2B illustrates a coordinate system of the road surface temperature (Z axis), the road surface unevenness (X axis), and the amount of moisture on the road surface (Y axis). FIG. 2C illustrates a two-dimensional map of a plane (1) in FIG. 2B. FIG. 2D illustrates a two-dimensional map of a plane (2) in FIG. 2B. FIG. 2E illustrates a two-dimensional map of a plane (3) in FIG. 2B. The road surface friction coefficient calculator 210 may apply the road surface temperature, the road surface unevenness, and the amount of moisture on the road surface acquired from the detection values by the first sensor 150 to the map in FIG. 2A to determine the road surface state.

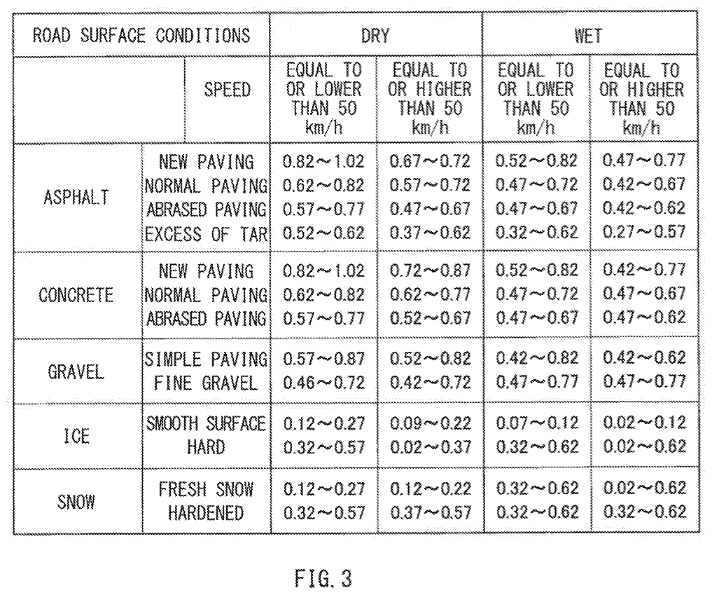

The road surface friction coefficient calculator 210 may calculate the coefficient of friction μN on the road surface by reflecting the road surface state determined from the map in FIG. 2A onto a database that defines, in advance, relation of road surface conditions and the coefficient of friction on the road surface. FIG. 3 is a schematic diagram illustrating an example of the database that defines, in advance, the relation of the road surface conditions and the coefficient of friction. The road surface conditions as used here may include the road surface states illustrated in FIG. 2A, e.g., dry (D), wet (W), snow (S), and ice (I), and paving states, e.g., asphalt, concrete, and gravel. In the database illustrated in FIG. 3, summarized vertically are values of the coefficient of friction corresponding to the following road surface conditions: “asphalt”, “concrete”, “gravel”, “ice”, and “snow”. Summarized laterally are values of the coefficient of friction corresponding to the following road surface conditions: “dry (D)” and “wet (W)”.

The road surface friction coefficient calculator 210 may apply the road surface state determined from the map in FIG. 2A to the database in FIG. 3, and thereby calculate the coefficient of friction μN on the road surface. At this occasion, a determination may be made as to which the road surface frontward of the vehicle includes, “asphalt”, “concrete”, “gravel”, “ice”, or “snow”, on the basis of a result of a determination on similarity between an image of the road surface acquired from the camera of the first sensor 150 and images of “asphalt”, “concrete”, “gravel”, “ice”, and “snow” acquired in advance.

Further, in a case with a determination that the road surface frontward of the vehicle includes “asphalt”, the road surface friction coefficient calculator 210 may determine which the road surface frontward of the vehicle includes, “new paving” of “asphalt”, “normal paving” of “asphalt”, “abrased paving” of “asphalt”, or “asphalt” in “excess of tar”, on the basis of a result of a determination on similarity between the image of the road surface acquired from the camera of the first sensor 150 and images of “new paving”, “normal paving”, “abrased paving”, and “excess of tar” acquired in advance. Likewise, the road surface friction coefficient calculator 210 is able to make a more subdivided determination, in a case with a determination that the road surface frontward of the vehicle includes “concrete”, “gravel”, “ice”, or “snow”.

As described above, the road surface friction coefficient calculator 210 may calculate a coefficient of friction μf on the road surface frontward of the vehicle from the database in FIG. 3 on the basis of the road surface conditions and the vehicle speed. For example, in a case with a determination from the image of the camera of the first sensor 150 that the road surface includes “new paving” of “asphalt”, with the vehicle speed detected from the vehicle speed sensor 170 being 40 km/h, and with a determination from the map in FIG. 2A that the road surface state is dry (D), a value of the coefficient of friction μf on the road surface is calculated as ranging from 0.82 to 1.02 both inclusive. In other words, the road surface friction coefficient calculator 210 may estimate the coefficient of friction on the road surface defined by a lower limit, e.g., 0.82, and an upper limit, e.g., 1.02.

The automated driving advisability determination unit 220 may determine whether to continue the automated driving on the basis of data acquired by the second sensor 160. The automated driving advisability determination unit 220 may determine that the automated driving is noncontinuable in a case where collection of appropriate sensor data by the second sensor 160 is barely available. In one specific but non-limiting example, the positional sensor, or the satellite positioning system such as the GPS, does not work well near a building or inside a tunnel. In such a case, the automated driving advisability determination unit 220 may determine that the automated driving is noncontinuable. Moreover, for example, the camera included in the second sensor 160 is not able to capture an appropriate image without an appropriate light source, e.g., during nighttime and under a backlit condition, or in unfavorable weather, e.g., dense fog, heavy rain, and heavy snow. Accordingly, the automated driving advisability determination unit 220 may determine that the automated driving is noncontinuable.

Furthermore, the millimeter wave radar included in the second sensor 160 is inferior to other sensors in terms of special resolution at the time of detection. For example, in a case with detection of an object having low reflectivity with respect to radio waves, e.g., a corrugated board box and styrene foam, it is difficult to identify such an object. Accordingly, the automated driving advisability determination unit 220 may determine that the automated driving is noncontinuable.

In addition, the laser radar included in the second sensor 160 utilizes infrared rays. This causes lowered detection performance in unfavorable weather such as heavy rain, heavy snow, and dense fog. In such a case, the automated driving advisability determination unit 220 may determine that the automated driving is noncontinuable.

Moreover, the automated driving advisability determination unit 220 may determine that the automated driving is noncontinuable in a case where the automated driving advisability determination unit 220 determines that the sensor does not work precisely because of a combination of the forgoing conditions.

Furthermore, the automated driving advisability determination unit 220 may determine that the automated driving is noncontinuable in a case with a sensor failure. Non-limiting examples of the sensor failure may include a damage or a malfunction of a key component of the second sensor 160.

The driving switching unit 260 may switch, in the case with the determination that the automated driving is noncontinuable, an operation mode from the automated driving to the manual driving. The vehicle controller 230 may control the vehicle braking and driving device 300. In one specific but non-limiting example, the vehicle controller 230 may control the vehicle braking and driving device 300, in the case with the determination that the automated driving is noncontinuable, and thereby impose a restriction on driving force of the vehicle in the manual driving. The restrictive value calculator 240 may calculate a restrictive value on the driving force of the vehicle in the case with the determination that the automated driving is noncontinuable. The information presentation processor 250 may control the information presentation device 500, in the case with the determination that the automated driving is noncontinuable, and thereby provide an occupant of the vehicle with presentation of information that indicates switching to the manual driving.

The vehicle braking and driving device 300 may perform braking and driving of the vehicle. In one specific but non-limiting example, the vehicle braking and driving device 300 may include, for example but not limited to, a motor, an engine, e.g., an internal combustion engine, and a frictional brake that drive a wheel of the vehicle and generate electric power by regeneration. The steering device 400 may perform steering of, mainly, a front wheel of the vehicle by a steering operation. The steering device 400 is able to perform the steering of the front wheel by driving force of an actuator. In one alternative, the steering device 400 may perform the steering of a rear wheel.

The information presentation device 500 may include, for example but not limited to, a display and a speaker that are installed in the vehicle. The information presentation device 500 may provide the occupant of the vehicle with the presentation of the information that indicates the switching from the automated driving to the manual driving, on the basis of an instruction from the information presentation processor 250.

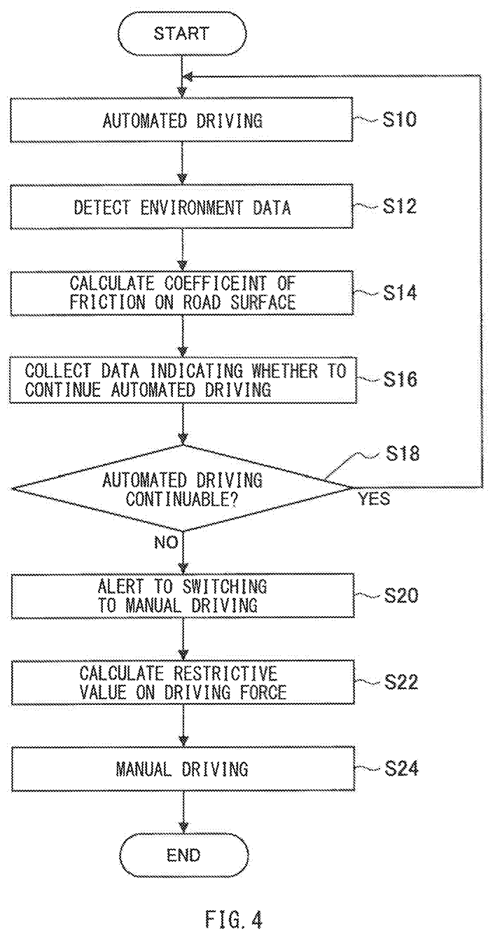

Described next, with reference to a flowchart of FIG. 4, is processing to be performed in the vehicle system 1000 according to this embodiment. First, in step S10, the vehicle including the vehicle system 1000 may perform the automated driving. The automated driving may be performed by allowing the vehicle controller 230 to control the vehicle braking and driving device 300 and the steering device 400 on the basis of the data detected by the second sensor 160.

Thereafter, in step S12, the first sensor 150 may detect the environment data for the calculation of the coefficient of friction on the road surface, in order to grasp the road surface state. Thereafter, in step S14, the road surface friction coefficient calculator 210 may calculate, on the basis of the data detected by the first sensor 150, the coefficient of friction on the road surface currently traveled by the vehicle.

Thereafter, in step S16, on the basis of the data detected by the second sensor 160, the automated driving advisability determination unit 220 may collect data indicating whether to continue the automated driving. Thereafter, in step S18, the automated driving advisability determination unit 220 may determine whether to continue the automated driving, on the basis of the data collected in step S16.

In step S18, in a case where the automated driving advisability determination unit 220 determines that the automated driving is continuable (step S18: YES), the processing may return to step S10. Meanwhile, in a case where the automated driving advisability determination unit 220 determines that the automated driving is noncontinuable (step S18: NO), the processing may proceed to step S20. In step S20, the occupant of the vehicle may be notified of an alert to the switching to the manual driving, that is, unautomated driving. The alert may be given by the information presentation processor 250 issuing a command to the information presentation device 500.

After step S20, the processing may proceed to step S22. In step S22, the restrictive value calculator 240 may calculate the restrictive value on the driving force of the vehicle in accordance with the road surface conditions. Thereafter, in step S24, the switching from the automated driving to the manual driving may be made. The manual driving may be performed on the basis of the restrictive value calculated in step S22.

In step S24, the occupant of the vehicle, or a driver, may perform an accelerator operation by the manual driving, while the vehicle braking and driving device 300 may impose the restriction on the driving force. At this occasion, in a case where the driving force of the vehicle as instructed by the acceleration operation is greater than the restrictive value calculated in step S22, the driving force of the vehicle may be restricted, with the restrictive value serving as an upper limit.

### EXAMPLE 1

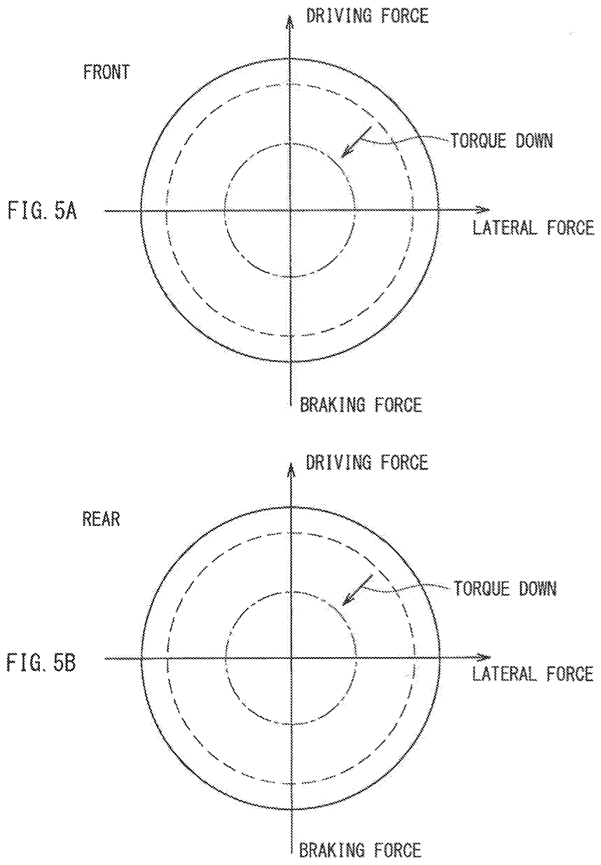

FIGS. 5A and 5B are schematic diagrams provided for description of the driving force set in accordance with the road surface conditions on the basis of the restrictive value calculated in step S22 in FIG. 4. In FIGS. 5A and 5B, front driving force for the front wheel and rear driving force for the rear wheel are indicated by restrictive friction circles. Friction circles indicated by broken lines in FIGS. 5A and 5B represent the driving force at timing of the determination that the automated driving is noncontinuable in step S18 in FIG. 4. In other words, the friction circles indicated by the broken lines in FIGS. 5A and 5B represent the driving force in the automated driving. Meanwhile, friction circles indicated by alternate long and short dashed lines in FIGS. 5A and 5B represent the driving force in the manual driving restricted by the restrictive value calculated in accordance with the road surface conditions in step S24 in FIG. 4.

In the calculation by the road surface friction coefficient calculator 210, the upper limit and the lower limit of the coefficient of friction μN on the road surface may be calculated on the basis of the database in FIG. 3. In step S22 in FIG. 4, the restrictive value on the driving force may be calculated by using the lower limit of the coefficient of friction on the road surface, i.e., a minimum coefficient of friction, in anticipation of safety. In one specific but non-limiting example, radii of the friction circles of the driving force indicated by the alternate long and short dashed lines in FIGS. 5A and 5B may be obtained by multiplying the lower limit of the coefficient of friction on the road surface calculated in step S14 by a vertical load of the wheel. The restriction on the driving force may be performed with respect to both the front driving force and the rear driving force. Thus, the driving force is controlled to be equal to or lower than the restrictive value with respect to both the front driving force and the rear driving force.

As described above, in the case where the automated driving is noncontinuable, the driving force or braking force to be produced by the vehicle braking and driving device 300 may be restricted to a value corresponding to the lower limit of the present coefficient of friction. Hence, it is possible to impose the restriction on the driving force in accordance with the present road surface state, making it possible to stabilize vehicle behavior in the switching from the automated driving to the unautomated driving, i.e., the manual driving. In particular, restricting the driving force to a value corresponding to the lower limit of the present coefficient of friction on the road surface makes it possible to restrict the driving force to a minimum value in anticipation of safety. Hence, it is possible to reliably stabilize the vehicle behavior.

In the forgoing Example, given is an example in which the driving force is restricted to the value corresponding to the lower limit of the present coefficient of friction on the road surface. It suffices, however, to set the restrictive value on the driving force on the basis of the present coefficient of friction on the road surface. The restrictive value does not have to take a value corresponding to the lower limit. For example, the restrictive value may be determined on the basis of a value between the upper limit and the lower limit of the coefficient of friction on the road surface. In another alternative, in a case with significantly high calculation accuracy of the coefficient of friction on the road surface, with a difference between the upper limit and the lower limit being significantly small, the restrictive value may be set on the basis of a coefficient of friction in anticipation of safety obtained by subtracting a predetermined amount from the calculated coefficient of friction on the road surface.

It is to be noted that in this embodiment, various techniques may be used as a technique of restricting the actual driving force on the basis of the restrictive value on the driving force. For example, an accelerator opening degree of the accelerator to be operated by the driver may be restricted, or alternatively, an accelerator opening speed may be restricted. In a case of an electric vehicle, electric power of a motor that drives a wheel may be restricted.

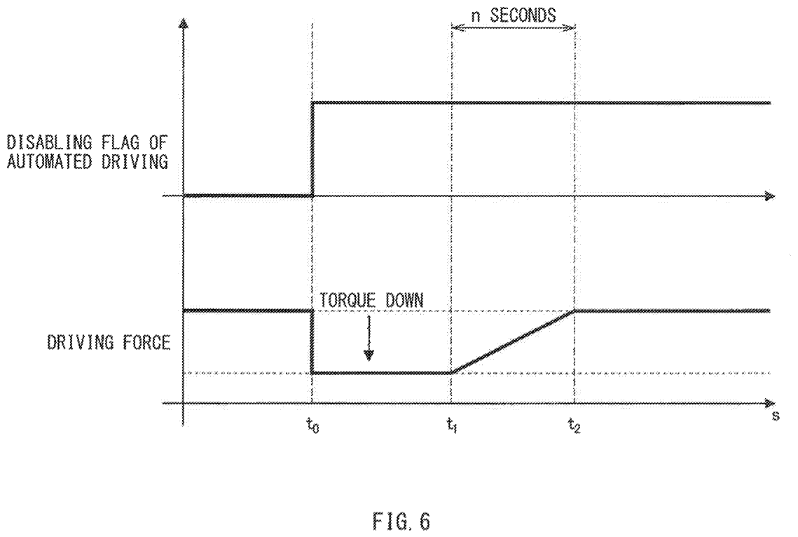

FIG. 6 is a timing chart illustrating how the driving force is restricted in the switching to the unautomated driving. FIG. 6 illustrates how states of a disabling flag of the automated driving and the restrictive value on the driving force for the front wheel and the rear wheel change with time.

In FIG. 6, time t0 indicates timing of the switching from the automated driving to the manual driving in step S24 in FIG. 4. Before time t0, the automated driving is performed, and the driving force for the front wheel and the rear wheel is restricted to driving force derived from the upper limit of the coefficient of friction calculated in step S14. At time t0, in the case where the determination is made that the automated driving is noncontinuable, the disabling flag of the automated driving may be turned on.

At time t0, in the case where the determination is made that the automated driving is noncontinuable, the driving force of the vehicle may lower, with the restrictive value calculated by the restrictive value calculator 240 serving as the upper limit, which imposes the restriction on the driving force for the front wheel and the rear wheel. The restrictive value on the driving force may correspond to the driving force derived from the lower limit of the coefficient of friction calculated in step S14, and correspond to the driving force of the friction circle indicated by the alternate long and short dashed lines in FIGS. 5A and 5B. This causes torque down with respect to the front wheel and the rear wheel. Hence, it is possible to stabilize the vehicle behavior in the switching from the automated driving to the unautomated driving, and leading to enhanced safety.

The torque down may be performed continuously until time t1. After time t1, the restrictive value on the driving force may be raised gradually. At time t2, the restrictive value on the driving force may be restored to the value before time t0. It is to be noted that as described above, the restrictive value on the driving force before time t0 may be the value derived from the upper limit of the coefficient of friction. Let us assume that time from time t1 to time t2 is predetermined time, e.g., n seconds. Raising the restrictive value on the driving force over n seconds makes it possible to prevent occurrence of an acceleration failure. In one alternative, after time t1, the restrictive value on the driving force may be raised gradually at a predetermined raising speed, and at time t2, the restrictive value on the driving force may be restored to the value before time t0.

In a case where at time t2, the coefficient of friction on the road surface calculated by the road surface friction coefficient calculator 210 has changed from that at timing of step S14, the driving force may be restricted on the basis of the coefficient of friction on the road surface at time t2. For example, in a case where the road surface state is “dry” before time t0 and the road surface state has changed to “ice” at time t2, the driving force may be restricted on the basis of the coefficient of friction on the road surface at time t2. This makes it possible to stabilize the vehicle behavior in response to a change in the road surface state in a transition period in which the switching is made from the automated driving to the manual driving.

Afterwards, in a case where the automated driving advisability determination unit 220 determines, on the basis of, for example, the data detected by the second sensor 160, that restoration to the automated driving is advisable, the restoration to the automated driving may be made.

### EXAMPLE 2

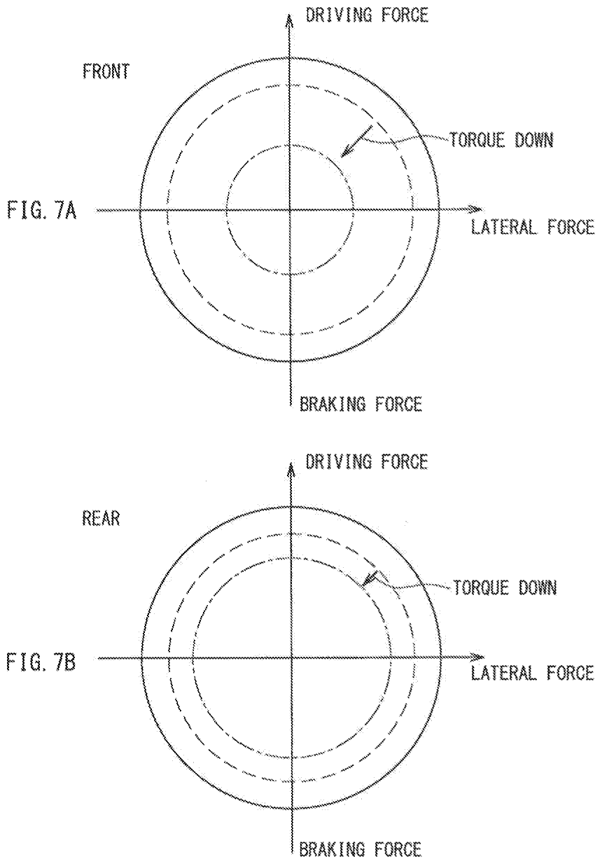

FIGS. 7A and 7B are schematic diagrams provided for description of the driving force set in accordance with the road surface conditions on the basis of the restrictive value calculated in step S22 in FIG. 4. Example 1 includes restricting an upper limit of braking and driving torque for the front wheel and the rear wheel on the basis of the minimum coefficient of friction. In contrast, Example 2 differs in the restriction on the driving force from Example 1 in that a torque restriction on a driving wheel is made smaller than a torque restriction on whichever wheel does not serve as the driving wheel, on the basis of the coefficient of friction. It is to be noted that within the description of the vehicle system 1000 according to Example 2, what is common to that of Example 1 is omitted.

In FIG. 7A, a radius of the friction circle of the driving force indicated by an alternate long and short dashed line may be obtained by multiplying the lower limit of the coefficient of friction on the road surface calculated in step S14 by the vertical load of the wheel.

In FIG. 7B, a friction circle indicated by an alternate long and short dashed line indicates the restrictive value on the rear driving force set in accordance with the restrictive value on the front driving force. As illustrated in FIG. 7B, the rear driving force may not be restricted as much as the front driving force. In other words, the front driving force may be allowed to be more restricted than the rear driving force. Here, the restrictive value on the rear driving force may be set, from the front and rear driving force distribution, on the basis of the restrictive value on the front driving force. For example, assuming that the driving force distribution is front:rear=4:6, the restrictive value on the rear driving force may be 1.5 times the restrictive value on the front driving force. It is to be noted that the front and rear driving force distribution may take a predetermined value that is determined from, for example, front and rear load distribution of the vehicle.

As described, in the case where the automated driving is noncontinuable, the driving force or the braking force for the front wheel to be produced by the vehicle braking and driving device 300 may be restricted to the value corresponding to the lower limit of the present coefficient of friction. Moreover, the driving force for the rear wheel may be determined in accordance with the front and rear driving force distribution. Hence, it is possible to restrict the driving force in accordance with the present road surface state, making it possible to stabilize the vehicle behavior in the switching from the automated driving to the unautomated driving, i.e., the manual driving. In particular, restricting the driving force for the front wheel to the value corresponding to the lower limit of the present coefficient of friction on the road surface makes it possible to restrict the driving force to the minimum value in anticipation of safety. Hence, it is possible to provide a margin for the lateral force, and to reliably stabilize the vehicle behavior. Furthermore, the driving force for the rear wheel may not be restricted as much as that of the front wheel. Hence, it is possible to reliably suppress, for example, the occurrence of the acceleration failure.

In the forgoing Example, given is an example in which the driving force for the front wheel may be restricted to the value corresponding to the lower limit of the present coefficient of friction on the road surface. However, it suffices to set the restrictive value on the driving force on the basis of the present coefficient of friction on the road surface. The restrictive value on the driving force does not have to take the value corresponding to the lower limit. For example, the restrictive value may be determined on the basis of a value between the upper limit and the lower limit of the coefficient of friction on the road surface. In another alternative, in the case with the significantly high calculation accuracy of the coefficient of friction on the road surface, with the difference between the upper limit and the lower limit being significantly small, the restrictive value may be set on the basis of the coefficient of friction in anticipation of safety obtained by subtracting the predetermined amount from the calculated coefficient of friction on the road surface.

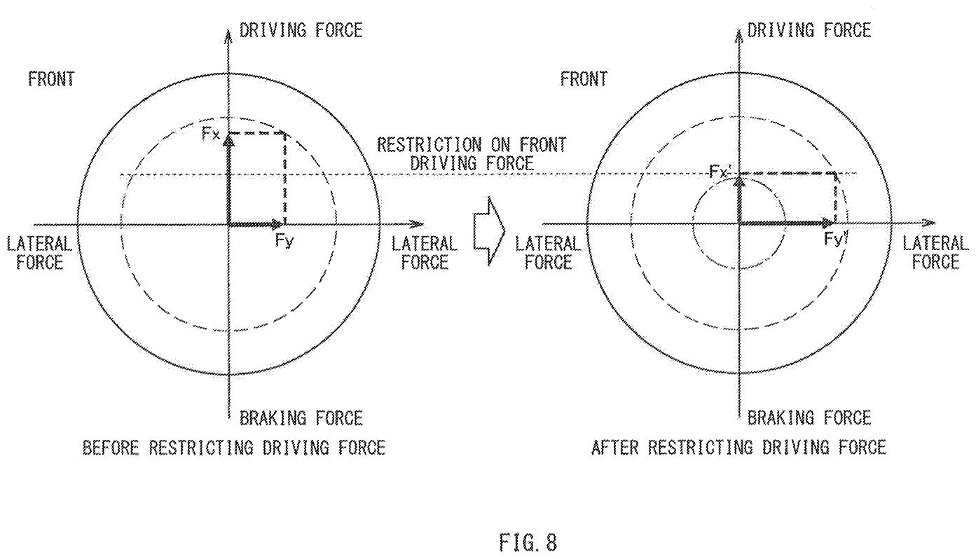

FIG. 8 schematically illustrates how a margin for front lateral force is generated by restricting the front driving force in FIG. 7A. In FIG. 8, before restricting the driving force, the front and rear driving force Fx is relatively large within a range of the friction circle indicated by a broken line, whereas the lateral force Fy is relatively small. In contrast, in FIG. 8, after restricting the driving force, as a result of restricting the front and rear driving force Fx′ to a range indicated by an alternate long and short dashed line, the lateral force Fy′ becomes larger than the lateral force Fy before restricting the driving force, within a range of the friction circle in the automated driving indicated by a broken line. This provides the margin for the lateral force, leading to enhanced turning performance. Hence, it is possible to reliably suppress occurrence of slippage even in a case with an abrupt steering operation after the switching to the manual driving.

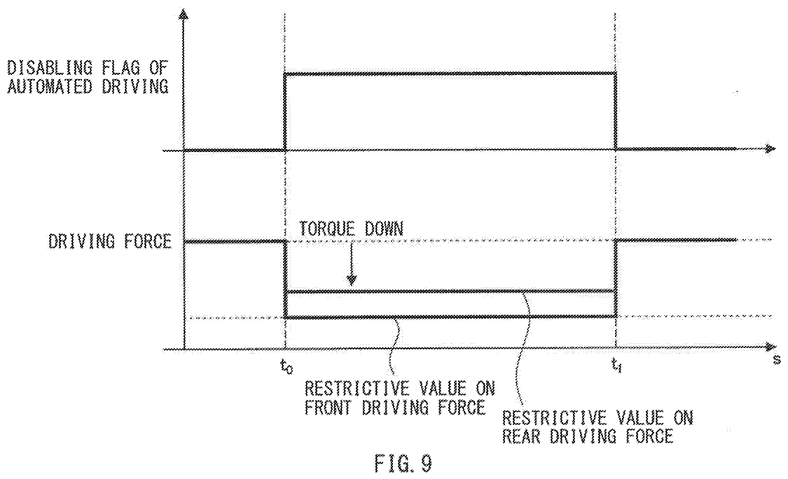

FIG. 9 is a timing chart illustrating how the driving force is restricted in the switching to the manual driving. FIG. 9 illustrates how the states of the disabling flag of the automated driving and the restrictive values on the driving force for the front wheel and the rear wheel change with time.

In FIG. 9, time t0 indicates the timing of the switching from the automated driving to the manual driving in step S24 in FIG. 4. Before time t0, the driving force for the front wheel and the rear wheel may be restricted to the driving force derived from the upper limit of the coefficient of friction calculated in step S14. At time t0, in the case where the determination is made that the automated driving is noncontinuable, the disabling flag of the automated driving may be turned on.

At time t0, in the case where the determination is made that the automated driving is noncontinuable, the restriction may be imposed on the driving force for the front wheel and the rear wheel. The restrictive value on the front driving force may correspond to the driving force derived from the lower limit of the coefficient of friction calculated in step S14, and correspond to the driving force of the friction circle indicated by the alternate long and short dashed line in FIG. 7A. The restrictive value on the rear driving force may be set, from the front and rear driving force distribution. For example, the restrictive value on the rear driving force may be 1.5 times the restrictive value on the front driving force. This causes the torque down with respect to the front wheel and the rear wheel, making it possible to stabilize the vehicle behavior in the switching from the automated driving to the unautomated driving, and leading to enhanced safety. In particular, it is possible to provide the margin for the front lateral force, leading to the enhanced turning performance. It is to be noted that in a case with a vehicle that performs steering with the rear wheel, the restrictive value on the rear driving force may be the driving force derived from the lower limit of the coefficient of friction, whereas the restrictive value on the front driving force may be set from the front and rear driving force distribution. This makes it possible to provide the margin for rear lateral force, leading to the enhanced turning performance.

At time t1, the automated driving advisability determination unit 220 may determine, on the basis of, for example, the data detected by the second sensor 160, that the restoration to the automated driving is advisable. Accordingly, after time t1, the disabling flag of the automated driving may be turned off. The torque down may be performed continuously until time t1. After time t1, the restrictive value on the driving force may be restored to the value before time t0. It is to be noted that as described above, the restrictive value on the driving force before time t0 may be the value derived from the upper limit of the coefficient of friction.

In a case where at time t1, the coefficient of friction on the road surface calculated by the road surface friction coefficient calculator 210 has changed from that at the timing of step S14, the driving force may be restricted on the basis of the coefficient of friction on the road surface at time t1. For example, in a case where the road surface state is “dry” before time t0 and the road surface state has changed to “ice” at time t1, the driving force may be restricted on the basis of the coefficient of friction on the road surface at time t1. This makes it possible to stabilize the vehicle behavior in response to the change in the road surface state in the transition period in which the switching is made from the automated driving to the manual driving.

In the forgoing description, an example is given in which the restrictive value on the front driving force may be set on the basis of the lower limit of the coefficient of friction on the road surface, whereas the restrictive value on the rear driving force may be set in accordance with the front and rear driving force distribution. In another alternative, the restrictive value on the rear driving force may be set on the basis of the lower limit of the coefficient of friction on the road surface, whereas the restrictive value on the front driving force may be set in accordance with the front and rear driving force distribution. For example, assuming that the driving force distribution is front:rear=4:6, the restrictive value on the front driving force may be 4/6 times the restrictive value on the rear driving force.

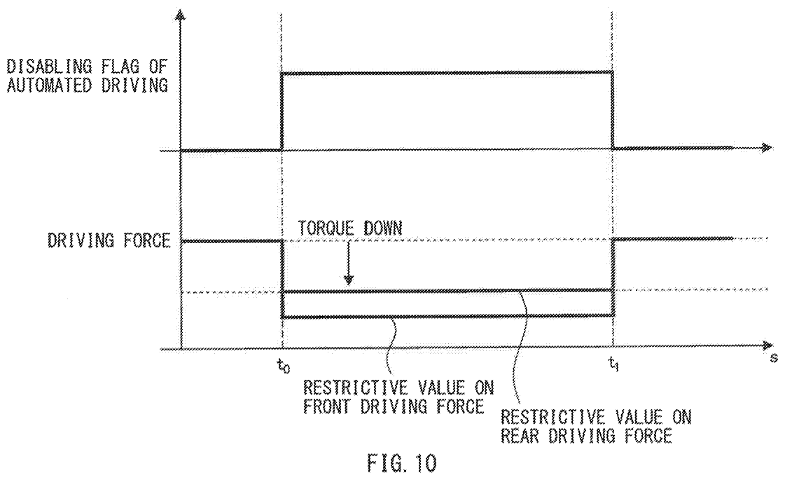

FIG. 10 is a timing chart illustrating how the driving force is restricted in a case where the restrictive value on the rear driving force is set on the basis of the lower limit of the coefficient of friction on the road surface, whereas the restrictive value on the front driving force is set in accordance with the front and rear driving force distribution. FIG. 10 illustrates how the states of the disabling flag of the automated driving and the restrictive values on the driving force for the front wheel and the rear wheel change with time.

In FIG. 10, time t0 indicates the timing of the switching from the automated driving to the manual driving in step S24 in FIG. 4. Before time t0, the driving force for the front wheel and the rear wheel may be restricted to the driving force derived from the upper limit of the coefficient of friction calculated in step S14. At time t0, in the case where the determination is made that the automated driving is noncontinuable, the disabling flag of the automated driving may be turned on.

At time t0, in the case where the determination is made that the automated driving is noncontinuable, the restrictive value on the driving force may lower, causing the restriction to be imposed on the driving force for the front wheel and the rear wheel. The restrictive value on the rear driving force may correspond to the driving force derived from the lower limit of the coefficient of friction calculated in step S14. The restrictive value on the front driving force may be set, from the front and rear driving force distribution. For example, the restrictive value on the front driving force may be 4/6 times the restrictive value on the rear driving force. This causes the torque down with respect to the front wheel and the rear wheel, making it possible to stabilize the vehicle behavior in the switching from the automated driving to the unautomated driving, and leading to enhanced safety. In particular, it is possible to provide the margin for the rear lateral force, leading to the enhanced turning performance.

At time t1, the automated driving advisability determination unit 220 may determine, on the basis of, for example, the data detected by the second sensor 160, that the restoration to the automated driving is advisable. Accordingly, after time t1, the disabling flag of the automated driving may be turned off. The torque down may be performed continuously until time t1. After time t1, the restrictive value on the driving force may be restored to the value before time t0.

In the case where the control illustrated in FIG. 10 is performed, total torque of the vehicle is reduced as compared with the control illustrated in FIG. 9. The reduction in the total torque, however, contributes to even more enhanced safety.

In the forgoing Example, given is an example in which the restrictive value on the front driving force or the rear driving force is calculated, and thereafter, calculated is the restrictive value on whichever remains unrestricted of the front driving force and the rear driving force, assuming that the driving force distribution is, for example, front:rear=4:6. However, the front and rear driving force distribution may differ according to specifications of the vehicle, and also differ according to a driving state such as a vehicle acceleration rate at the time of driving. In an alternative, therefore, ideal driving force distribution may be calculated in consideration of these factors, to calculate the restrictive value on whichever remains unrestricted of the front driving force and the rear driving force on the basis of the ideal driving force distribution.

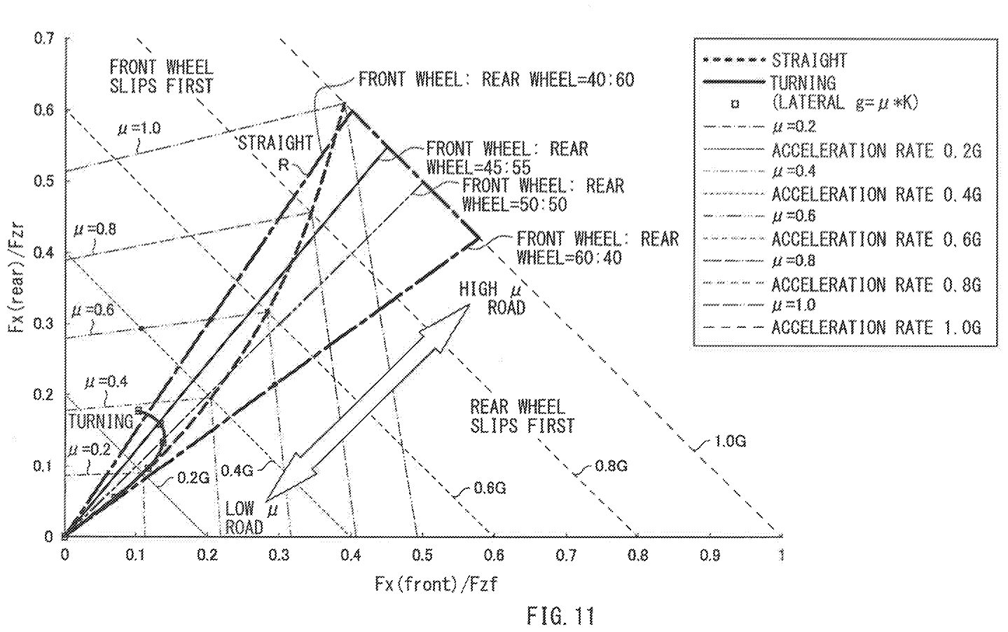

The ideal driving force distribution may be calculated by an ideal driving force distribution calculator 270. In the following, described is a calculation method of the ideal driving force distribution. FIG. 11 schematically illustrates an ideal driving force diagram. The ideal driving force diagram in FIG. 11 illustrates the ideal driving force distribution of the front wheel or the rear wheel with respect to the vehicle acceleration rate, and may be obtained from vehicle weight, a wheel base, a height of a center of gravity, and a roll flexibility.

In FIG. 11, a horizontal axis represents a ratio (=Fx(front)/Fzf) of longitudinal force Fx(front) of the front wheel to a grounding load Fzf of the front wheel. Here, assuming that a grounding load with the front wheel resting is Fzf0 and a quantity of movement of a load by acceleration is ΔFzx, the grounding load Fzf of the front wheel may be calculated by the following expression (1).

Fzf=Fzf0−ΔFzx (1)

Moreover, in FIG. 11, a vertical axis represents a ratio (=Fx(rear)/Fzr) of longitudinal force Fx(rear) of the rear wheel to a grounding load Fzr of the rear wheel. Here, assuming that a grounding load with the rear wheel resting is Fzr0 and the quantity of movement of the load by the acceleration is ΔFzx, the grounding load Fzr of the rear wheel may be calculated by the following expression (2).

Fzr=Fzr0+ΔFzx (2)

The quantity of movement of the load ΔFzx by the acceleration may be calculated by the following expression (3) using the vehicle weight m, the longitudinal acceleration rate a, the height of the center of gravity hg, and the wheel base l.

ΔFzx=(m·a·hg)/(2·l) (3)

In FIG. 11, a curve indicated by a solid line indicates a characteristic of the vehicle on straight travel. A curve indicated by an alternate long and short dashed line indicates a characteristic of the vehicle at the time of turning.

In FIG. 11, five dash-double dot lines indicate respective cases with the coefficient of friction μ on the road surface being μ=0.2, μ=0.4, μ=0.6, μ=0.8, and μ=1.0. Five broken lines indicate respective cases with the acceleration rate being 0.2 G, 0.4 G, 0.6 G, 0.8 G, and 1.0 G.

According to FIG. 11, on the straight travel, at the acceleration rate of 0.2 G, the ideal driving force distribution is given by the front and rear driving force distribution of the front wheel:the rear wheel=about 52:48. In this state, it is possible to output the driving force to its limit on the road surface with μ=0.2. At the acceleration rate of 0.6 G, the ideal driving force distribution is given by the front and rear driving force distribution of the front wheel:the rear wheel=about 47:53. In this state, it is possible to output the driving force to its limit on the road surface with μ=0.6.

The ideal driving force distribution calculator 270 may calculate, on the basis of the ideal driving force diagram in FIG. 11, the ideal driving force distribution in accordance with the driving state by applying, for example, the vehicle acceleration rate to the ideal driving force diagram in FIG. 11. The vehicle acceleration rate may be obtained from, for example, the vehicle speed sensor 170. A control method based on FIG. 11 may include distributing the front driving force and the rear driving force so as to basically provide the ideal driving force distribution indicated by the region R. That is, the front and rear driving force distribution may assume a range from the front wheel:the rear wheel=40:60 to the front wheel:the rear wheel=60:40, both inclusive.

The control device 200 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control device 200. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control device 200 illustrated in FIG. 1.

Although some preferred but non-limiting embodiments of the technology are described above by way of example with reference to the accompanying drawings, the technology is by no means limited to the embodiments described above. It should be appreciated that modifications and alterations may be made by persons skilled in the art without departing from the scope as defined by the appended claims. The use of the terms first, second, etc. does not denote any order or importance, but rather the terms first, second, etc. are used to distinguish one element from another. The technology is intended to include such modifications and alterations in so far as they fall within the scope of the appended claims or the equivalents thereof.

1. A vehicle control device, comprising
a processor configured to
estimate a coefficient of friction on a road surface to be traveled by a vehicle,
determine whether to continue automated driving on a condition that the vehicle is performing the automated driving, and
impose a restriction on driving force of the vehicle in manual driving on a basis of a restrictive value derived from the coefficient of friction estimated, on a condition that a determination is made that the automated driving is noncontinuable.

2. The vehicle control device according to claim 1, wherein
the processor
estimates the coefficient of friction defined by an upper limit and a lower limit, and
imposes the restriction on the driving force on a basis of a first restrictive value derived from the lower limit of the coefficient of friction.

3. The vehicle control device according to claim 1, wherein
after imposing the restriction on the driving force, the processor takes predetermined time to remove the restriction.

4. The vehicle control device according to claim 2, wherein
after imposing the restriction on the driving force, the processor takes predetermined time to raise the first restrictive value derived from the lower limit to a second restrictive value derived from the upper limit.

5. The vehicle control device according to claim 4, wherein
after imposing the restriction on the driving force, the processor raises, at a predetermined raising speed, the first restrictive value derived from the lower limit to the second restrictive value derived from the upper limit.

6. The vehicle control device according to claim 1, wherein
the driving force includes driving force for a front wheel and driving force for a rear wheel, and
the processor imposes the restriction on both the driving force for the front wheel and the driving force for the rear wheel.

7. The vehicle control device according to claim 6, wherein
the processor
estimates the coefficient of friction defined by an upper limit and a lower limit, and
imposes the restriction on the driving force for the front wheel or the driving force for the rear wheel on a basis of a first restrictive value derived from the lower limit of the coefficient of friction estimated, while imposing the restriction on whichever remains unrestricted of the driving force for the front wheel and the driving force for the rear wheel on a basis of a second restrictive value derived from the first restrictive value and distribution of the driving force for the front wheel and the driving force for the rear wheel.

8. The vehicle control device according to claim 7, wherein
the distribution of the driving force for the front wheel and the driving force for the rear wheel is determined by specifications of the vehicle or a driving state of the vehicle, or both.

9. The vehicle control device according to claim 7, wherein
the distribution of the driving force for the front wheel and the driving force for the rear wheel takes a predetermined value.

10. The vehicle control device according to claim 7, wherein
the processor imposes the restriction on the driving force for the front wheel on the basis of the first restrictive value.

11. The vehicle control device according to claim 7, wherein
the processor imposes the restriction on the driving force for the rear wheel on the basis of the first restrictive value.

12. The vehicle control device according to claim 7, wherein
the processor imposes the restriction on the driving force for whichever of the front wheel and the rear wheel performs steering, on the basis of the first restrictive value.

13. The vehicle control device according to claim 6, wherein
the processor allows the driving force for the front wheel to be more restricted than the driving force for the rear wheel.

14. The vehicle control device according to claim 1, wherein
the processor makes switching to the manual driving on the condition that the determination is made that the automated driving is noncontinuable

15. A vehicle control method, comprising:
estimating a coefficient of friction on a road surface to be traveled by a vehicle on a basis of data detected by a sensor;
determining whether to continue automated driving on a condition that the vehicle is performing the automated driving; and
imposing a restriction on driving force of the vehicle in manual driving on a basis of a restrictive value derived from the coefficient of friction estimated, on a condition that a determination is made that the automated driving is noncontinuable.

16. A non-transitory computer-readable recording medium containing a program, the program causing, when executed by a computer, the computer to implement a method, the method comprising:
estimating a coefficient of friction on a road surface to be traveled by a vehicle on a basis of data detected by a sensor;
determining whether to continue automated driving on a condition that the vehicle is performing the automated driving; and
imposing a restriction on driving force of the vehicle in manual driving on a basis of a restrictive value derived from the coefficient of friction estimated, on a condition that a determination is made that the automated driving is noncontinuable.
